(19) United States
(12) Patent Application Publication
(10) Pub. No.: US 2022/0121783 A1
(43) Pub. Date: Apr. 21, 2022

(54) MESH SIMPLIFICATION APPARATUS AND PROGRAM FOR MESH SIMPLIFICATION

(71) Applicant: Nihon Unisys, Ltd., Tokyo (JP)

(72) Inventor: Shoichi TSUCHIE, Tokyo (JP)

(21) Appl. No.: 17/426,305

(22) PCT Filed: Mar. 19, 2019
(86) PCT No.: PCT/JP2019/011326

§ 371 Date: Jul. 28, 2021

(30) Foreign Application Priority Data
Jan. 29, 2019 (JP) 2019-012782

(51) Int. Cl. G06F 30/10

(52) U.S. Cl. CPC G06F 30/10

(57) ABSTRACT

A mesh simplification apparatus includes a flip determination unit 2 to determine whether or not a flip of a triangular element that constitutes a mesh will occur when one side, called an edge, of the triangular element is contracted, an avoidance processing unit 3 to perform processing to avoid occurrence of the flip when it is determined that the flip will occur, and an edge contraction unit 4 to contract the edge as it is when it is determined that no flip will occur and to contract the edge after performing the processing to avoid occurrence of the flip when it is determined that the flip will occur. Even in the case where no edge contraction has been performed because the flip occurs by conventional methods, introduction of the avoidance processing unit 3 makes it possible to reduce the number of elements of the mesh as many as possible, that is to simplify the mesh.

### TECHNICAL FIELD

The present invention relates to mesh simplification apparatus and programs for mesh simplification and, in particular, relates to a technique to perform mesh simplification with respect to shape data including significantly fine mesh elements to express a delicate shape change.

### BACKGROUND ART

In general, in designing a product, shape data of the product is generated by CAD (Computer Aided Design). As a method of generating shape data, a method is widely adopted in which, from scanned data of an object to serve as a model, a surface model of the object is reconstructed by the CAD. For example, in the case of a surface shape of an automobile, CAD data is reconstructed from scanned data of a clay model created by clay modelers using clay scrapers (curve rulers).

In scanned design data of a clay model, for example, a subtle change in shape created by a designer is important. In order to represent the subtle change, the scanned design data is measured with an extremely fine pitch. As a result, a mesh including a vast number of elements is generated. However, because such a mesh leads to an increase in calculation load, it is required to reduce the number of the elements of the mesh by appropriate data processing that keeps the difference from the original data within an error tolerance. Mesh elements employed in the invention are triangles. Note that a mesh made of triangular facets will be hereinafter referred to as triangle mesh.

As a method of simplification of a mesh, there is known a contraction method of a side, called an edge, of a triangular facet that constitutes the mesh (see, for example, patent document 1). Patent document 1 discloses that only when a predetermined condition is satisfied, both endpoints of an edge are contracted into a midpoint of the edge. That is, a fitting apparatus disclosed in patent document 1 performs contraction when neither of both the endpoints of the edge is on a characteristic boundary and also when the edge itself is not the characteristic boundary. As a result, while the mesh formed by the processing is in a state of maintaining design characteristics of original data as many as possible, the mesh can be simplified.

However, in simplification of the mesh by simple edge contraction, as illustrated in FIG. 9, a triangular facet having a topological defect called a flip is easily generated. FIG. 9(a) illustrates a triangle mesh to serve as the original data. As contraction of an edge connecting two vertices A and B, two cases will now be considered, that is, a case of merging the vertex B with the vertex A as illustrated in FIG. 9(b), and a case of merging the vertex A with the vertex B as illustrated in FIG. 9(c).

In the case of FIG. 9(c) that exhibits intersection of edges, a flip occurs in a triangular facet including the Intersecting edges. Edge contraction that causes the flip is regarded as invalid processing, and mesh simplification by such edge contraction is not allowed. There is known a technique where a determination is made as to whether or not a flip occurs so that when the flip occurs, mesh simplification is not performed (see, for example, patent documents 2 to 5).

Patent Document 1:Japanese Unexamined Patent Application Publication No. 2006-277712.

Patent Document 2: Japanese Patent No.4,701,119

Patent Document 3: Japanese Patent No. 4,714,444

Patent Document 4:Japanese Unexamined Patent Application Publication No. 2005-242647.

Patent Document 5:Japanese Unexamined Patent Application Publication No. 2005-242651.

### DISCLOSURE OF THE INVENTION

### Problems to be Solved by the Invention

As disclosed in patent documents 2 to 5, when mesh simplification by edge contraction is not performed in the case of occurrence of a flip, there is caused a problem that the mesh simplification is performed less sufficiently as input data includes more of such edges.

The invention has been achieved to solve the above-described problem, and it is an object of the invention to reduce the number of facets of a triangle mesh in a simplification process of the mesh by edge contraction without generating an facet having a topological defect called a flip.

### Means for Solving the Problems

In order to solve the above-described problem, according to the invention, when an edge, which is one side of a triangular facet that constitutes a mesh, is contracted, it is determined whether or not a flip of the triangular facet will occur. When it is determined that no flip will occur, the edge is contracted as it is. Meanwhile, when it is determined that the flip will occur, the edge is contracted after processing to avoid occurrence of the flip is performed.

### Effects of the Invention

According to the invention having the above-described configuration, even in the case where no edge contraction has been conventionally performed owing to occurrence of a flip, edge contraction is performed after the predetermined processing to avoid occurrence of the flip is performed. Thus, even when the input mesh includes a large number of edges that may cause flips, the number of facets of the mesh can be reduced by edge contraction without generating an facet having a topological defect called the flip.

### BRIEF DESCRIPTION OF THE DRAWINGS

FIG. 1 is a block diagram illustrating a function configuration example of a mesh simplification apparatus according to this embodiment.

FIG. 2 is a diagram illustrating details of processing by a flip determination unit according to this embodiment.

FIG. 3 is a diagram illustrating a first processing method (smoothing) performed by an avoidance processing unit according to this embodiment.

FIG. 4 is a diagram illustrating a second processing method (swapping) performed by the avoidance processing unit according to this embodiment.

FIG. 5 is a diagram illustrating an example of contraction of an edge of interest in a state generated as a result of the smoothing by the avoidance processing unit according to this embodiment.

FIG. 6 is a diagram illustrating an example of contraction of an edge of interest in a state generated as a result of the swapping by the avoidance processing unit according to this embodiment.

FIG. 7 is a diagram illustrating an example of processing for each neighborhood of an edge where no overlapping occurs.

FIG. 8 is a flowchart, of an operation example by the mesh simplification apparatus according to this embodiment.

FIG. 9 is a diagram illustrating a flip of a triangular facet caused by edge contraction.

### MODE FOR CARRYING OUT THE INVENTION

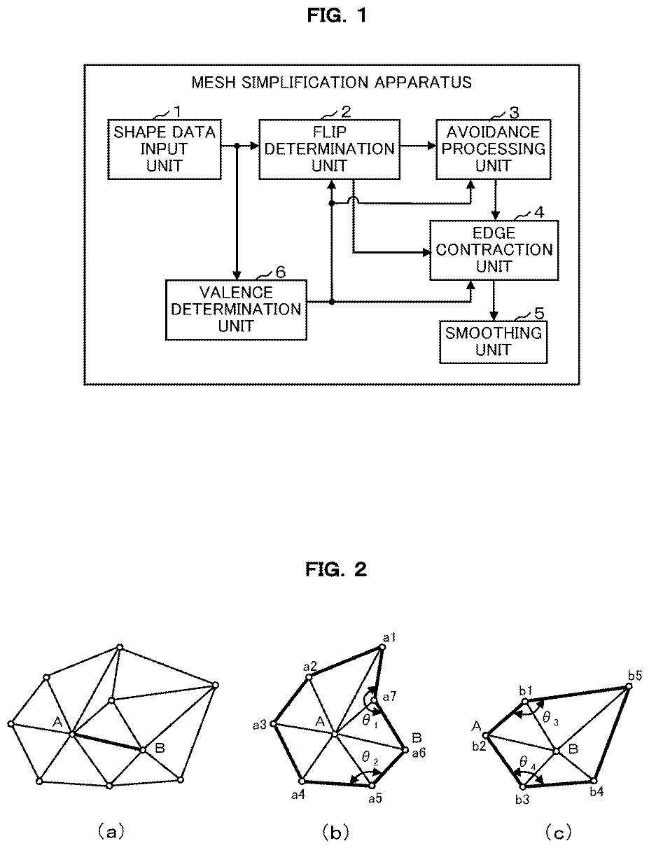

Hereinafter, one embodiment of the invention will be described with reference to the drawings. FIG. 1 is a block diagram illustrating a function configuration example of a mesh simplification apparatus according to this embodiment. As illustrated in FIG. 1, the mesh simplification apparatus according to this embodiment includes, as a function configuration, a shape data input unit 1, a flip determination unit 2, an avoidance processing unit 3, an edge contraction unit 4, a smoothing unit 5, and a valence determination unit 6.

Any of hardware, a DSP (Digital Signal Processor), and software can constitute each of these function blocks 1 to 6. For example, when software constitutes each of the function blocks 1 to 6, each of the function blocks 1 to 6 actually includes a CPU, a RAM, a ROM, and the like of a computer and is implemented by operating a program stored in recording media such as the RAM, the ROM, a hard disk, or a semiconductor memory.

The shape data input unit 1 inputs shape data represented by a triangle mesh. In this embodiment, a triangle mesh given as scanned data of a shape of a clay model, for example, is input. Each triangular facet of the mesh includes three vertices and three edges connecting the vertices. Adjacent mesh elements share vertices and edges.

The mesh simplification apparatus according to this embodiment simplifies the triangle mesh input by the shape data input unit 1 so as to reduce the number of triangles while maintaining design characteristics of original data as many as possible. Mesh simplification is performed by edge contraction. In particular, in this embodiment, as illustrated in FIG. 9, when an edge connecting two vertices A and B is contracted, the vertex B is merged with the vertex A or the vertex A is merged with the vertex B.

When edge contraction is successively performed, it is necessary to determine an order of edges to be contracted (hereinafter referred to as edges of interest). In this embodiment, the contraction is performed in increasing order of length of the edges. Note that when contraction of a certain edge of interest is performed, edges in the vicinity change in length so that it is necessary to logically determine the order of edges of interest. This will be detailed later.

As to a certain edge of interest of the triangle mesh input by the shape data input unit 1, the flip determination unit 2 determines whether or not contraction of the edge of interest causes a flip of a mesh element (a triangular facet). In this embodiment, the flip determination unit 2 determines whether or not any of the following interior angles is 180 degrees or larger: interior angles of a figure defined by edges that connect the other endpoints of a plurality of edges connected to a first endpoint of the edge of interest; and interior angles of a figure defined by edges that connect the other endpoints of a plurality of edges connected to a second endpoint of the edge of interest. Then, when some of the interior angles is 180 degrees or larger, the flip determination unit 2 determines that a flip of the mesh element will occur.

FIG. 2 is a diagram illustrating details of processing by the flip determination unit 2. FIG. 2(a) illustrates the triangle mesh to serve as the original data. This is the same diagram as FIG. 9(a). Suppose now that an edge connecting the two vertices A and B is an edge of interest, and that the flip determination unit 2 determines whether or not a flip will occur when this edge is contracted.

First, as illustrated in FIG. 2(b), the flip determination unit 2 detects interior angles θ₁ and θ₂ of a first figure defined by edges that connect the other endpoints a1 to a7 of a plurality of edges (seven edges in this example) connected to the first endpoint A of the edge of interest. As illustrated in FIG. 2(c), the flip determination unit 2 detects interior angles θ₃ and θ₄ of a second figure defined by edges that connect the other endpoints b1 to b5 of a plurality of edges (five edges in this example) connected to the second endpoint B of the edge of interest. Here, the four interior angles θ₁ to θ₄ are interior angles of common vertices of the first figure and the second figure.

The flip determination unit 2 determines whether or not any of these interior angles θ₁ to θ₁ is 180 degrees or larger. When some of the interior angles is 180 degrees or larger, the flip determination unit 2 determines that a flip of the mesh element will occur. In the example of FIG. 2, because the interior angle θ₁ is 180 degrees or larger, the flip determination unit 2 determines that contraction by merging the vertex A with the vertex B will cause a flip.

When the flip determination unit 2 determines that a flip of a mesh element will occur, the avoidance processing unit 3 performs predetermined processing to avoid occurrence of the flip. There are two kinds of processing methods as follows, and one of the methods may be applied.

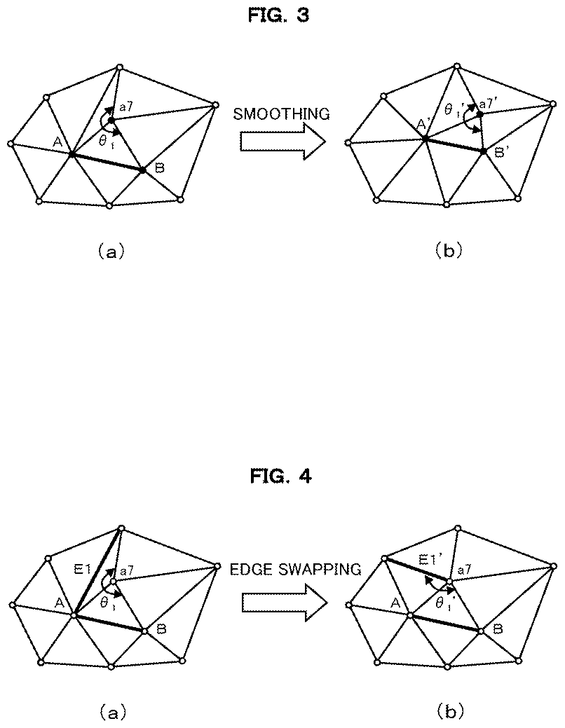

As a first processing method, the avoidance processing unit 3 moves a vertex that causes an interior angle of 180 degrees or larger so as to make the interior angle less than 180 degrees. In order to move the vertex, smoothing of a triangle (processing to make the triangle as close to a regular triangle as possible) is applied. FIG. 3 is a diagram illustrating this first processing method (smoothing). FIG. 3(a) is the same diagram as FIG. 2(a) and illustrates a state prior to the smoothing, and FIG. 3(b) illustrates a state after the smoothing. The vertex a7 that causes the interior angle θ₁ of 180 degrees or larger is moved to a vertex a7′, and both the endpoints A and B of the edge of interest are moved to vertices A′ and B′. Such smoothing makes an interior angle θ₁′ defined anew at the vertex a7′ equal to or less than 180 degrees.

A known technique is applicable as a processing method for the smoothing. Here, an example of smoothing the mesh by moving the three vertices a7, A, and B has been described. However, only the vertex a7 that causes the interior angle of 180 degrees or larger may be moved.

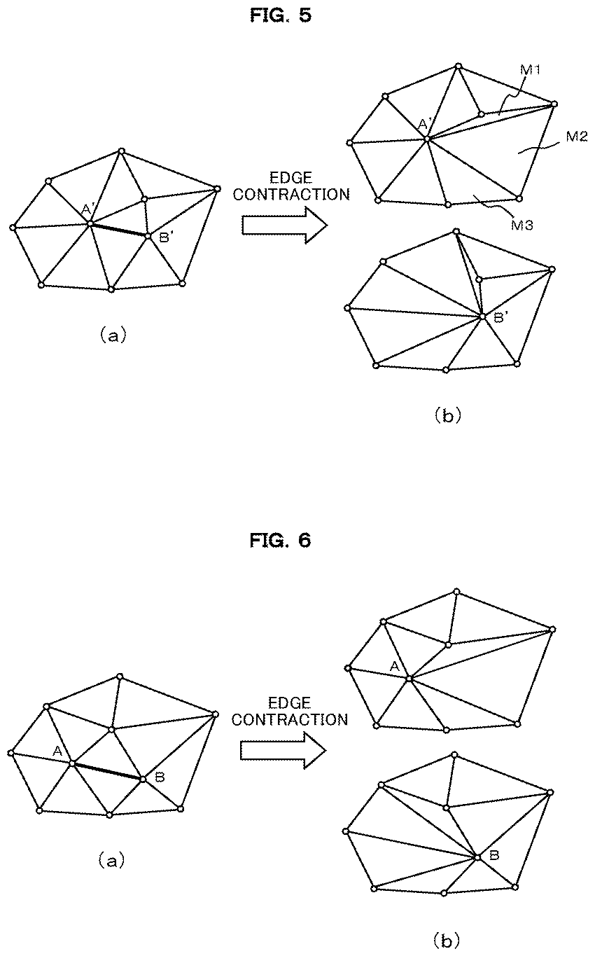

As a second processing method, the avoidance processing unit 3 performs edge swapping. Of the mesh including a vertex that causes an interior angle of 180 degrees or larger, an edge equivalent to a subtense of the vertex of the mesh that is on the interior angle side is replaced with an edge connected to the vertex so as to make the interior angle less than 180 degrees. FIG. 4 is a diagram illustrating this second processing method (edge swapping). FIG. 4(a) is the same diagram as FIG. 2(a) and illustrates a state prior to the edge swapping, and FIG. 4(b) illustrates a state after the edge swapping. An edge E1 equivalent to a subtense of the vertex a7 that causes the interior angle of 180 degrees or larger is replaced with an edge E1′ connected to the vertex a7. Such edge swapping makes the interior angle θ₁′ defined anew at the vertex a7 equal to or less than 180 degrees.

This edge swapping is equivalent to processing of replacing diagonals of a quadrilateral formed by two mesh elements that share the edge E1 equivalent to the subtense of the vertex a7. A known technique is also applicable for this.

When the flip determination unit 2 determines that a flip of the mesh element will occur, the edge contraction unit 4 contracts the edge of interest in a state after the avoidance processing unit 3 has performed the predetermined processing (a state of FIG. 3(b) or FIG. 4(b)). Meanwhile, when the flip determination unit 2 determines that no flip of the mesh element will occur, the edge contraction unit 4 contracts the edge of interest in a state where the avoidance processing unit 3 does not perform the predetermined processing.

FIG. 5 is a diagram illustrating an example of contraction of the edge of interest in a state of FIG. 3(b) generated as a result of the smoothing by the avoidance processing unit 3. FIG. 5(a) illustrates a state prior to the edge contraction, and FIG. 5(b) illustrates a state after the edge contraction. FIG. 5(a) is the same diagram as FIG. 3(b). As illustrated in FIG. 5(b), even when the edge contraction is performed by merging the vertex B′ with the vertex A′ and even when the edge contraction is performed by merging the vertex A′ with the vertex B′, no flip of the mesh elements occurs.

FIG. 6 is a diagram illustrating an example of contraction of the edge of interest in a state of FIG. 4(b) generated by the edge swapping by the avoidance processing unit 3. FIG. 6(a) illustrates a state prior to the edge contraction, and FIG. 6(b) illustrates a state after the edge contraction. FIG. 6(a) is the same diagram as FIG. 4(b). As illustrated in FIG. 6(b), even when the edge contraction is performed by merging the vertex B with the vertex A and even when the edge contraction is performed by merging the vertex A with the vertex B, no flip of the mesh occurs.

The smoothing unit 5 performs smoothing to make a long and narrow triangular facet, which may be generated by contraction of the edge of interest by the edge contraction unit 4, closer to a regular triangle. For example, as illustrated in the upper side of FIG. 5(b) where the edge contraction is performed by merging the vertex B′ with the vertex A′, three mesh elements M1 to M3 are deformed by the edge contraction. The smoothing unit 5 smooths the three mesh elements M1 to M3 and mesh elements in the vicinity of the mesh elements M1 to M3.

Note that when a shape represented by the mesh is a surface (when the shape is not necessarily a simple planar shape), the vertices after the smoothing to make a triangular facet close to a regular triangle may be separated from the original mesh that has been input by the shape data input unit 1. In order to prevent this phenomenon, processing may be performed to project the smoothed vertices onto a nearest point of the original mesh.

The above-described processing ends the contraction of one edge of interest and the smoothing of the related mesh elements. In this embodiment, such processing is applied to other edges and performed successively. As described above, a strategy as to what rules are adopted to perform edge contraction successively is important. In this embodiment, two methods are adopted. A first method is to determine an edge of interest in each one neighborhood of an edge. A second method is to determine an edge of interest by assessing valences of both endpoints of an edge. Hereinafter, these methods will be described one by one.

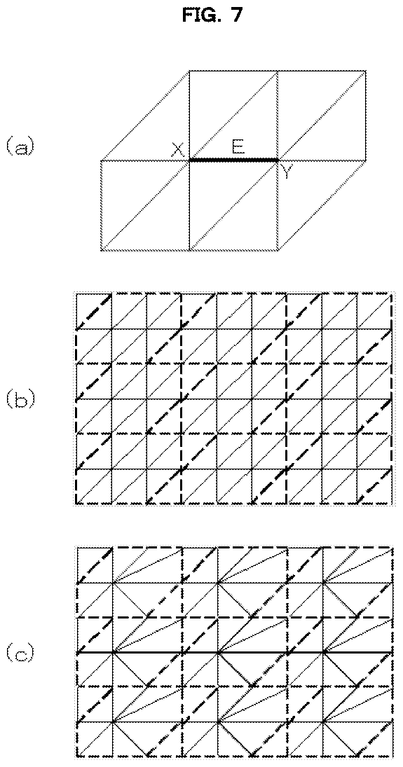

First, the first method of determining an edge of interest will fee described. One neighborhood of an edge is defined as illustrated in FIG. 7(a). The one neighborhood of the edge illustrated in FIG. 7(a) refers to a group of edges included in a plurality of triangular facets that share, as one of vertices, one of vertices X and Y at both endpoints of a certain edge E. When an edge of interest is determined anew, one neighborhood of the new edge of interest is prevented from overlapping one neighborhood of an edge that has been already contracted. That is, new edges of interest are determined successively in such a mode that one neighborhood of an edge that has been already contracted does not overlap one neighborhood of an edge of interest selected anew.

FIG. 7(b) illustrates an example of one neighborhood of the edge where no overlapping occurs. FIG. 7(c) illustrates a state after edges of interest included in a range of a certain neighborhood are contracted. When edge contraction processing is performed over an entire area of the input mesh, a new edge of interest having one neighborhood where no overlapping occurs can be no longer selected. However, in this case, information that edge contraction has been performed is cleared once, and edge contraction is repeated.

In this manner, edge contraction processing is performed for each one neighborhood where no overlapping occurs so that edge contraction can be prevented from being concentrated in the vicinity of an identical position. Note that although the one neighborhood of the edge is exemplified here, the way to set a neighborhood of an edge may be freely designed.

Next, the second method of determining an edge of interest will be described. When edge contraction is performed, not only lengths of related edges in the vicinity are changed but also valences of vertices after the contraction are changed. A valence is the number of edges connected to a vertex. Suppose, for example, that edge contraction of FIG. 9(b) is performed with respect to FIG. 9(a). In this case, a valence of the vertex A was “7” prior to the contraction but is “8” after the contraction,

When an edge having large valences at both endpoints is contracted, the valences of the vertices after the contraction increases further, and mesh elements connected to the vertices have extremely long and narrow triangular shapes. When the smoothing is performed to make a shape of each facet of the triangle mesh as close to a regular triangle as possible, the valence is desirably “6” or a value as close to “6” as possible. In this embodiment, to generate a mesh that include extremely long and narrow triangles as less as possible, valences are assessed to determine edges of interest.

The valence determination unit 6 assesses whether or not a sum of valences of both endpoints of an edge of interest exceeds a predetermined value. For example, suppose that the valence determination unit 6 assesses whether or not to contract an edge connecting the two vertices A and B in the mesh illustrated in FIG. 2(a). In this case, the valence of the vertex A is “7”, and the valence of the vertex B is “5” so that a sum of the valences is “12”. The valence determination unit 6 assesses whether or not the sum of the valences exceeds a predetermined value Vsum (e.g., Vsum=12). Then, only when the valence determination unit 6 assesses that the sum of the valences does net exceed the predetermined value Vsum, the processing by the flip determination unit 2, the avoidance processing unit 3, and the edge contraction unit 4 are performed.

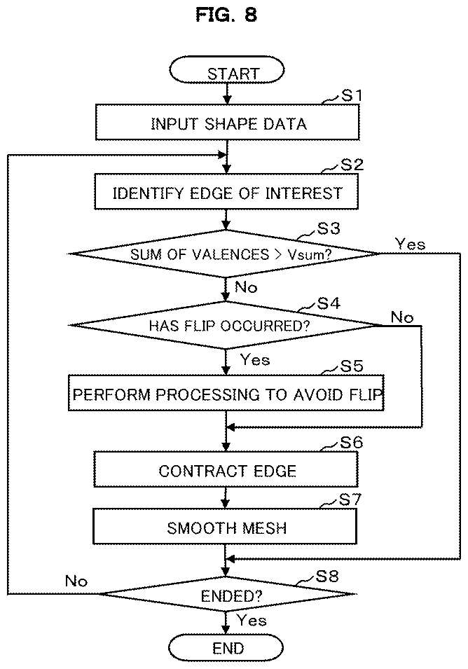

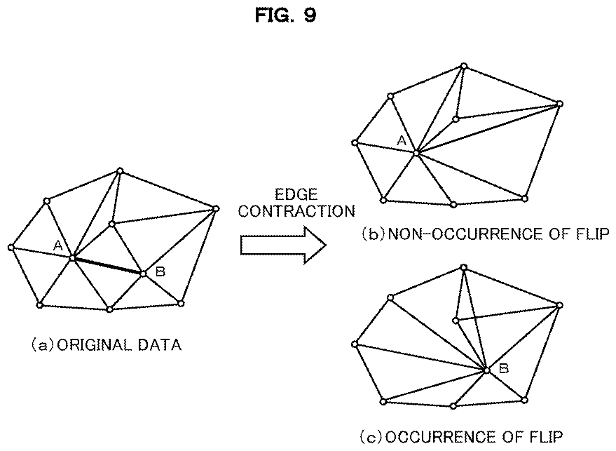

FIG. 8 is a flowchart of an operation example by the mesh simplification apparatus according to this embodiment that has the above-described configuration. First, in the shape data input unit 1, a triangle mesh to serve as shape data of a model is input (step S1). Next, the mesh simplification apparatus sorts and identifies edges of interest from among a plurality of edges that constitute the input triangle mesh (step S2).

At this step S2, the mesh simplification apparatus makes a list where the edges of the triangle mesh input by the shape data input unit 1 are sorted in increasing order of length, and sets an “unprocessed” flag on each of the edges. Then, edges of interest are identified in turn from the top of the list. If “unprocessed” flags are set on an identified edge of interest and edges in its one neighborhood, processing at and after step S3 is performed, and “processed” flags are set on the edge of interest and the edges in its one neighborhood that have been processed. Meanwhile, if a “processed” flag is set on any of the identified edge of interest and the edges in its one neighborhood, a different edge in a region other than the one neighborhood is identified as an edge of interest.

The valence determination unit 6 assesses whether or not a sum of valences of both endpoints of each edge of interest thus identified exceeds the predetermined value Vsum (step S3). When the sum of valences exceeds the predetermined value Vsum, processing shifts to step S8.

Meanwhile, when the valence determination unit 6 assesses that the sum of valences of both the endpoints of the edge of interest does not exceed the predetermined value Vsum, the flip determination unit 2 determines whether or not a flip of a mesh element occurs when the edge of interest identified at step S2 is contracted (step S4). Here, when it is determined that the flip will occur, the avoidance processing unit 3 performs the predetermined processing (smoothing or swapping) on mesh elements that exist in the vicinity of the edge of interest to avoid occurrence of the flip (step S5). Then, the edge contraction unit 4 contracts the edge of interest in a state after the predetermined processing is performed by the avoidance processing unit 3 (step S6).

Meanwhile, when the flip determination unit 2 determines that no flip will occur at step S4, processing skips step 35 and shifts to step S6. In this case, the edge contraction unit 4 contracts the edge of interest in a state where the predetermined processing is not performed by the avoidance processing unit 3. Thereafter, the smoothing unit 5 performs such smoothing that long and narrow triangular facets, which may be generated by the contraction of the edge of interest by the edge contraction unit 4, will be made close to regular triangles (step S7).

After the above-described processing of the one edge of interest has been ended, the mesh simplification apparatus determines whether or not a predetermined ending condition is satisfied (step S8). For example, when a simplification ratio achieved (such as the ratio of the number of simplified mesh elements to the number of initial mesh elements) reaches a predetermined value, it may be determined that the ending condition is satisfied. Alternatively, when edge contraction is performed a predetermined number of times, it may be determined that the ending condition is satisfied. When the ending condition is not satisfied, the processing returns to step S2. Note that when the processing of steps S2 to S7 is repeated, edges with “unprocessed” flags no longer exist, which results in a state where the contraction processing cannot be performed (a state illustrated in FIG. 7(c)). In this case, the mesh after undergoing the contraction processing as illustrated in FIG. 7(c) is regarded as an input mesh so as to change the “processed” flag to an “unprocessed” flag, and processing from step S2 is continued Meanwhile, when the ending condition is satisfied, the processing in the flowchart illustrated in FIG. 8 is ended.

As described in derail above, in this embodiment, it is determined whether or not a flip of a mesh element occurs when an edge of interest is contracted in the triangle mesh that represents shape data of the model. When it is determined that no flip will occur, the edge of interest is contracted as it is. Meanwhile, when it is determined that the flip will occur, a triangular facet in the vicinity of the edge of interest is subjected to the predetermined processing to avoid occurrence of the flip, and thereafter the edge of interest is contracted.

According to the embodiment having this configuration. even when it is determined that contraction of an edge will cause a flip of a mesh element, the edge is not simply contracted but the edge is subjected to the predetermined processing to avoid occurrence of the flip and thereafter contraction of the edge is performed. Thus, the number of triangular facets that constitute the mesh can be reduced, that is, the mesh can be simplified.

Note that in the above description of the embodiment, although one of the smoothing and the edge swapping is performed as the predetermined processing to avoid occurrence of the flip, both of the smoothing and the swapping may be performed. For example, the smoothing may be performed in relation to the edge of interest that causes a flip until a first ending condition concerning a ratio of mesh simplification is satisfied, and thereafter the swapping may be performed in relation to the edge of interest that causes a flip until a second ending condition concerning a ratio of mesh simplification is satisfied. These may be performed in a reverse order.

In the embodiment, an example, is described in which the mesh is smoothed by the smoothing unit 5 after the edge contraction by the edge contraction unit 4. However, the invention is not limited to this. For example, in addition to the mesh smoothing after the edge contraction, the mesh smoothing may be also performed immediately after the shape data is input by the shape data input unit 1. This makes it possible to omit the smoothing in flip avoiding processing by the avoidance processing unit 3.

In the embodiment, when the edge connecting the two vertices A and B is contracted, the vertex B is merged with the vertex A or the vertex A is merged with the vertex B. However, the invention is not limited to this. For example, the two vertices A and B may be contracted to a midpoint thereof. Contraction with respect to the midpoint of the edge is considered to be mesh simplification equivalent to Laplacian smoothing. When such contraction is repeated to implement the simplification, noise of the mesh can be smoothed at the same time.

In this embodiment, an example is described in which it is determined whether or not to contract the edge of interest based on an assessment of the valence. In addition to this, it may be determined whether or not to contract the edge of interest based on other conditions. For example, it may be determined whether or not the edge of interest corresponds to a characteristic portion (such as a ridgeline or a boundary) of the shape of the model, and the edge corresponding to the characteristic portion may not be contracted. Deviation between the shape before the edge contraction and the shape after the edge contraction may be detected, and when the deviation exceeds predetermined values, the contraction may not be performed.

In particular, when the shape represented by the mesh is a surface, the valence being “6” is not necessarily regarded as an ideal condition to make the shape of the triangular facet close to a regular triangle. In this case, it is effective to limit edges to be contracted to edges that do not belong to characteristic portions. The reason is that shapes of portions other than the characteristic portions are relatively simple and have smooth change in curvature so that substantially the same way of considering the valence as in the case of a planar surface can be applied

In any of other respects, the embodiment is only provided as an embodying example to implement the invention, and a technical scope of the invention should not be construed in a limiting sense based on this example. That is, the invention can be implemented in various manners without departing from the subject matter or major characteristics of the invention.

### DESCRIPTION OF REFERENCE NUMERALS AND SIGNS

1: shape data input unit

2: flip determination unit

3: avoidance processing unit

4: edge contraction unit

5: smoothing unit

6: valence determination unit

1. A mesh simplification apparatus characterized by comprising:
a shape data input unit configured to input shape data represented by a mesh comprising triangular facets;
a flip determination unit configured to determine, as to an edge of interest, which is one side of a triangular facet of the mesh, whether or not a flip of the triangular facet will occur when the edge of interest is contracted;
an avoidance processing unit configured to, when the flip determination unit determines that the flip will occur, perform predetermined processing to avoid occurrence of the flip; and
an edge contraction unit configured to, when the flip determination unit determines that the flip will occur, perform contraction of the edge of interest in a state after the avoidance processing unit performs the predetermined processing, and when the flip determination unit determines that no flip will occur, perform contraction of the edge of interest in a state where the avoidance processing unit does not perform the predetermined processing.

2. The mesh simplification apparatus according to claim 1, characterized in that the flip determination unit is configured to determine whether or not any of following interior angles is 180 degrees or larger: interior angles of a figure defined by edges that connect other endpoints of a plurality of edges connected to a first endpoint of the edge of interest; and interior angles of a figure defined by edges that connect other endpoints of a plurality of edges connected to a second endpoint of the edge of interest, and the flip determination unit is configured to, when some of the interior angles is 180 degrees or larger, determine that the flip of the mesh will occur.

3. The mesh simplification apparatus according to claim 2, characterized in that the avoidance processing unit is configured to move a vertex that causes the interior angle of 180 degrees or larger by triangle smoothing so as to make the interior angle less than 180 degrees.

4. The mesh simplification apparatus according to claim 2, characterized in that the avoidance processing unit is configured to, among mesh elements comprising a vertex that causes the interior angle of 180 degrees or larger, perform swapping by replacing an edge corresponding to a subtense of the vertex of a mesh element on the interior angle side with an edge connected to the vertex so as to cause the interior angle of 180 degrees or larger to be less than 180 degrees.

5. The mesh simplification apparatus according to claim 1, characterized by further comprising a smoothing unit configured to perform smoothing to make a long and narrow triangular facet, which may be generated by contraction of the edge of interest by the edge contraction unit, closer to a regular triangle.

6. The mesh simplification apparatus according to claim 1, characterized in that the edge contraction unit is configured to determine the edge of interest from the shape data input by the shape data input unit in such a mode that a neighboring edge of the edge of interest does not overlap a neighboring edge of an edge already contracted, and the edge contraction unit is configured to perform the edge contraction successively.

7. The mesh simplification apparatus according to claim 1, characterized by further comprising a valence determination unit configured to assess whether or not a sum of valences of both endpoints of the edge of interest exceeds a predetermined value,
wherein only when the valence determination unit determines that the sum of valences does not exceed the predetermined value, the flip determination unit, the avoidance processing unit, and the edge contraction unit are configured to perform processing.

8. A program for mesh simplification stored on a non-transitory computer readable medium characterized by causing a computer to function as:
shape data input means for inputting shape data represented by a mesh comprising triangular facets;
flip determination means for determining, as to an edge of interest, which is one side of a triangular facet of the mesh, whether or not a flip of the triangular facet will occur when the edge of interest is contracted;
avoidance processing means for, when the flip determination means determines that the flip will occur, performing predetermined processing to avoid occurrence of the flip; and
edge contraction means for, when the flip determination means determines that the flip will occur, performing contraction of the edge of interest in a state after the avoidance processing means performs the predetermined processing, and when the flip determination means determines that no flip will occur, performing contraction of the edge of interest in a state where the avoidance processing means does not perform the predetermined processing.

9. The mesh simplification apparatus according to claim 5, characterized by further comprising a valence determination unit configured to assess whether or not a sum of valences of both endpoints of the edge of interest exceeds a predetermined value, wherein only when the valence determination unit determines that the sum of valences does not exceed the predetermined value, the flip determination unit, the avoidance processing unit, and the edge contraction unit are configured to perform processing.
